(19) United States
(12) Patent Application Publication
(10) Pub. No.: US 2008/0128094 A1
(43) Pub. Date: Jun. 5, 2008

(54) Evaporation Source Device

(76) Inventor: Tatsuo Fukuda, Chiba-ken (JP)

Correspondence Address: Quarles & Brady, 411 E. Wisconsin Ave., Milwaukee, WI, 53202, US

(21) Appl. No.: 11/665,879

(22) PCT Filed: Oct. 20, 2005
(86) PCT No.: PCT/JP05/19746

§ 371 Date: Sep. 28, 2007

(30) Foreign Application Priority Data
Oct. 21, 2004 (JP) 2004-307474

(51) Int. Cl. B01D 1/22

(52) U.S. Cl. 159/6.1; 159/5; 159/7

(57) ABSTRACT

An evaporation source device comprises a fusion section 24, a retainer section 21, an evaporator section 22, and an ejector section 23. When cylindrical heaters 241 and 211 are electrically energized, a linear evaporation material 31 is fused. A molten evaporation material 32 runs from a heating container 242 and retains in a heating container 212. The evaporation material 32 in the heating container 212 runs down from a descending opening 216 along a descending column 224. The evaporation material 32 evaporates by the radiation heat from the cylindrical heater 221 on the falling process. The vapor of the evaporation material 32 is ejected from the nozzle 232 onto the substrate 61. Each of the cylindrical heaters 241, 211, 221, and 231, which is made of graphite, generates heat when a voltage is applied between electrodes 213 and 214, between electrodes 214 and 222, or between electrodes 232 and 233.

### TECHNICAL FIELD

The present invention relates to an evaporation source device used suitably for a vacuum deposition apparatus which forms a film of a material which is melded through heating and then evaporated (vaporized). The present invention also relates to a so-called enclosed type evaporation source device which has at least one vapor ejection opening of a size in which vapor can maintain its spouting phenomenon due to a pressure difference between the inside and outside of a crucible of the evaporation source device.

### BACKGROUND ART

A conventional vacuum evaporation apparatus and a conventional enclosed-type evaporation source device (which hereinafter merely called an evaporation source device) will be explained by referring to FIGS. 17 and 18, respectively (for example, refer to patent document 1).

FIG. 17 is a cross sectional view schematically illustrating a vacuum deposition apparatus. FIG. 18 is a cross sectional view schematically illustrating an evaporation source device. In FIGS. 17 and 18, like reference numerals attached to the same constitute elements.

A vacuum deposition apparatus will be first explained below by referring to FIG. 17.

Referring to FIG. 17, numeral 11 represents an evaporation source device, 121 represents a vacuum chamber (room), 122 represents a support member for a substrate 123, and 124 represents a support member for an evaporation source device. The evaporation source device 11 includes a crucible 111 and a heating coil 113. The crucible 111 contains a solid evaporation material 114.

When the heating coil 113 heats the crucible 111, the evaporation material 114 vaporizes and ejects from the nozzle (ejection opening) to the vacuum chamber 121 to form a deposited film over the substrate 123. In FIGS. 17 and 18, the evaporation source device uses a heating coil for heating the crucible 111. However, as the heating method, there are electron bombardment or other methods. However, since the common factor is to melt and evaporate an evaporation material in a crucible by the heat of the crucible, an example using a heating coil will be explained below, without referring to other heating methods.

Next, an evaporation source device will be explained by referring to FIG. 18.

In the evaporation source device 11 shown in FIG. 18(a), the crucible 111 contains a solid evaporation material 114. When the heating coil 113 is energized electrically, the crucible 111 is heated. In this case, the portion of the evaporation material 114, which is in contact with the crucible 111, indicates a highest temperature. The evaporation material, which is apart from the crucible 111, indicates a lower temperature. As the temperature rises, the evaporation material 114 begins to melt from portions in contact with the crucible 111 and then liquefies the whole of the evaporation material. While the liquefied evaporation material convects through the following heating, it evaporates from the surface in contact with the space (the top surface the evaporation material 114 in FIG. 18(a)). The vaporized evaporation material is sprayed from the nozzle (ejection opening) 112 onto the substrate 123.

The enclosed-type crucible has an internal pressure.

However, the evaporated gas, which does not exhaust from the nozzle 112, is re-liquefied so that a dynamic equilibrium state is maintained in the space within the crucible 111. In that state, even if the heating temperature is not carefully controlled, the continuous heating process boils the molten material. The liquid evaporation material spatters from the nozzle 112. This phenomenon, which is called splash, causes a loss of the evaporation material 114, bombards the substrate to damage the deposited film and makes unstable the evaporation amount per time. By suppressing the heating temperature to prevent the splash, the evaporation amount decreases, so that the evaporation amount reduces and the film forming rate becomes slow. However, the film forming rate relates to the production costs. In order to suppress a decrease of evaporation amount to prevent the splash, even a little, a splash prevention barrier (bulkhead) has disposed in the crucible.

FIG. 18(b) shows an evaporation source device 11 which has splash prevention barriers (bulkheads) 1161 and 1162 disposed within the crucible 111.

Referring to FIG. 18(b), a cylindrical member 1172, a barrier 1162, a cylindrical member 1171, and a barrier 1161 are disposed within the crucible 111. The evaporation material 114 is placed on the bottom of the crucible 111. The cylindrical members 1171 and 1172 and barriers 1161 and 1162 are detachable. The barrier 1161 has two openings and the barrier 1162 has one opening.

At the setup step of a deposition work, the evaporation material 114 is placed within the crucible 111. Then, the barrier 1162, having an opening of a suitable size, is placed on the cylindrical member 1172. The cylindrical members 1171 and 1161 are placed above the barrier 1162. The barriers 1162 and 1161 block the spattering of the boiled liquid of the evaporation material 114, so that the molten evaporation material does not spatter (splash) from the nozzle 112. The opening of the barrier 1162, being a vapor passing mouth, is larger than the nozzle 112. Even if only the barrier 1162 is disposed in the crucible 111, the possibility that splash passes through the opening of the barrier 1162 and then ejects from the nozzle 112 is lower than that in the case where the barrier 1162 is not disposed. However, the barrier 1161 having two openings is disposed to further reduce splash. Since the splash passes through the opening of the barrier 1162 and strikes the barrier 1161, the possibility that splash reaches the nozzle 112 is further reduced. Since the barriers 1161 and 1162 are maintained at a high temperature by conductive heat, the splash in contact with the barriers 1162 and 1161 is vaporized.

In the conventional enclosed-type crucible, because the nozzle is only the opening communicated to the outside, the evaporation material is supplied by disassembling the crucible at the setup operation. Each of the crucibles 111, shown in FIGS. 18(a) and 18(b), comprises two parts including an upper portion and a lower portion. The upper and lower portions are fitted to each other. When the evaporation material 114 is stored or refilled, the crucible 111 is taken out from the heating mechanism, which includes the heating coil 113, and then is separated into the upper portion and the lower portion. After the evaporation material 114 is refilled in the lower crucible, the lower crucible and the upper crucible are fitted together. The integrated structure is re-assembled to the heating mechanism. In the installation of the barrier, the parts are piled in the order of the cylindrical member 1172, the barrier 1162, the cylindrical member 1171, and the barrier 1161, before fitting the upper and lower crucibles together.

Patent document 1: Japanese Patent publication No. 5-41698

### DISCLOSURE OF THE INVENTION

Since the conventional enclosed-type crucible tends to cause splash, as described above, the method has been generally employed for disposing a barrier in a crucible to prevent splash. However, it is difficult to completely prevent the splash using the barrier. The reason is that when a desired ejection amount of vapor gas is required, the vapor gas passing aperture of the barrier cannot be small sized excessively or the number of barriers cannot be increased. Reducing the opening of a barrier or increasing the number of barriers leads to increasing the gas pressure in the crucible. Since the conversion amount of the generated vapor from vapor phase into liquid phase increases, the ejection amount of the vaporized gas from the nozzle reduces. In other words, since increasing the ejection amount contradicts the function of the barrier, the barrier arranging method has the problem that the splash prevention effect is uncertain and that ascertaining the splash prevention effect results in a decrease of ejection amount.

The enclosed-type crucible, shown in FIG. 18, is not large generally and cannot contain a large amount of an evaporation material at a time. Therefore, the enclosed-type crucible is very difficult to provide a long time period of deposition and to obtain a large amount of evaporation.

The factor of suppressing the size of a crucible relates to the thermal distribution of a crucible. In the crucible shown in FIG. 18, the side surface is heated to a high temperature directly by the heating coil. However, the upper surface of the crucible, or, the nozzle area, does not exceed the side temperature because the heat conducted from the side surface heats the upper surface. Generally, the nozzle, which is positioned at the center of the upper surface of a crucible, is most spaced away from the side surface or is positioned at the area of a lowest temperature. This means that a nozzle temperature may cause the vapor to be liquefied at the nozzle position, thus resulting in a cease of ejection. That phenomenon restricts the size of the enclosed-type crucible. The nozzle arranged area shown in FIG. 18, which is surrounded with walls (or surrounded cylindrically), is used to prevent the temperature of the nozzle from falling. Increasing the temperature of the side surface to increase the nozzle temperature leads to violent boiling of an evaporation material, so that splash becomes significant. A complicated heating mechanism can heat forcedly the area where the nozzle is disposed. However, the control becomes complicated as described below.

That is, before an evaporation material is placed into the crucible, the crucible is taken out from the heating mechanism. The crucible is disassembled into the lower part and the upper part and the barrier and the cylindrical member are removed. An evaporation material is placed on the bottom of the lower crucible. Then, the barrier and the cylindrical member are re-assembled and the upper crucible is integrally fitted in the lower crucible. The integrated crucible is loaded again to the heating mechanism. This successive work, which is not required for crucibles except the enclosed-type crucible, is one reason that the enclosed-type crucible is not used. To forcedly heat the area where the nozzle of a crucible is disposed, a heating coil must be disposed around the area. Therefore, the work of removing the crucible from the heating mechanism becomes more complicated. Because of that constraint, it has been considered that the enclosed-type crucible cannot increase the evaporation amount and deposit a film at high rate.

Nevertheless, the evaporation by the enclosed-type crucible has a large advantage. In the open-type crucible, the translation rate of vapor to a substrate is a sonic speed depending on the condition at the spot. In contrast, in the enclosed-type crucible, the translation rate becomes a supersonic speed, increased by an ejection force obtained. This phenomenon makes it possible to form a good deposited film because of a large kinetic energy of vapor. Moreover, the cluster ion beam technique is known as important means for obtaining a high quality vapor growth film. However, that technique requires an enclosed-type crucible and the advantage thereof cannot be fully utilized on the condition that the conventional enclosed-type crucible is used. If the disadvantage of the conventional enclosed-type crucible is solved, the evaporation amount can be improved to form a film at high rate. Moreover, an improved film quality can be expected by applying the cluster ion beam technique.

An object of the present invention is to provide a enclosed-type evaporation source device capable of solving drawbacks of the conventional enclosed-type evaporation source device, that is, occurrence of splash, unstable evaporation amount, difficulty in obtaining a large volume of evaporation, incapable long-time evaporation, and difficult handling of a crucible in initial setup.

### Means For Solving The Problems

In order to achieve the above-mentioned object, an evaporation source device for a vacuum deposition apparatus comprises a retainer section for retaining an evaporation material in molten state; and an evaporator section for evaporating the evaporation material in molten state. The evaporation material in molten state passes from the retainer section to the evaporator section through a descending opening between the retainer section and the evaporator section by gravity. A vapor ejection opening is formed in part of a cylindrical heater in the evaporator section. The molten evaporation material, which has passed from the retainer section to the evaporator section, is evaporated by ambient radiation heat, while the molten evaporation material is descending with the molten evaporation material in no contact with an inner wall of the cylindrical heater in the evaporator, and the vapor ejection opening ejects vapor.

The evaporation source device according to the present invention further comprises a descending column disposed in the evaporator section. The molten evaporation material descends on a surface of the descending column.

In the evaporation source device according to the present invention, a surface of the descending column has a pear-skin roughness, a helical groove, a ring-shaped groove, or a vertical groove.

In the evaporation source device according to the present invention, the descending column has a nearly erect conical shape or a nearly inverted conical shape.

In the evaporation source device according to the present invention, the descending column can move vertically and the head of the descending column has a size or shape which can block or narrow the descending opening.

In the evaporation source device according to the present invention, a cylindrical heater in the injector section is coupled to the ejection opening in the evaporator section, the cylindrical heater in the ejector section having an ejection opening.

In the evaporation source device according to the present invention, the ejection opening of the ejector section has a shape of nozzle or slit.

In the evaporation source device according to the present invention, the retainer section melts and liquefies a solid evaporation material.

In the evaporation source device according to the present invention, an evaporation material fused and liquefied in the retainer section is supplied to the evaporator section continuously or intermittently before or during deposition.

In another aspect of the present invention, an evaporation source device for a vacuum deposition apparatus comprises a fusion section for melting a solid evaporation material; a retainer section for retaining an evaporation material in a molten state; and an evaporator section for evaporating the evaporation material in molten state. The inside of the fusion section and the inside of the retainer section is communicated through an opening for refilling an evaporation material in molten state. The inside of the retainer section and the inside of the evaporator section is communicated through an opening for descending an evaporation material in molten state. The evaporator section has a vapor ejection opening. The molten evaporation material in the evaporator section descends while being in no contact with the inner wall of a cylindrical heater in the evaporator section.

In the evaporation source device according to the present invention, the descending column is rotatable.

The evaporation source device according to the present invention further comprises an adjuster for adjusting the opening area of the descending opening and adjusting the amount which the molten evaporation material falls into the evaporator.

In the evaporation source device according to the present invention, the shape of the head of the descending column is flat or concave.

In the evaporation source according to the present invention, the surface of said descending column has a helical groove, the upper end of the helical groove protruding from the head of the descending column.

In the evaporation source device according to the present invention, the surface of the descending column has a helical groove having a crest and a root. A path for the evaporation material is formed such that a protrusion is formed adjacent to the top surface of the crest and radially and outward or such that the top surface of the crest is elevated radially and outward.

### EFFECT OF THE INVENTION

In an evaporation source device according to the present invention, an evaporation material in molten state descends in a cylindrical heater in an evaporator section, while it is in contact with the inner wall thereof. The molten evaporation material is not heated with the conduction heat but is heated with only the radiation heat from the cylindrical heater. Therefore, the molten evaporation material does not boil due to sensible heat. In other words, since the molten evaporation material vaporizes, without boiling, the so-called splash, by which part of the molten material spatters, does not occur.

Because splash causes a loss of an evaporation material, the evaporation amount becomes unstable. Splash also strikes the substrate and damages the evaporated film. However, the evaporation source device according to the present invention does not generate splash so that the yield in evaporation process can improve drastically. Moreover, the evaporation source device according to the present invention does not require the barrier disposed in the conventional enclosed-type evaporation source device.

The evaporation source device of the present invention includes a fusion section, a retainer section, an evaporator section, and an ejector section, in which the temperature can be controlled independently. Therefore, each section can be finely adjusted to a necessary temperature. In the evaluation source device of the present invention, a combination of the retainer section and the evaporator section enables deposition by forming an ejection opening in the evaporator section. In such a case, the deporation stabilized for a long time can be realized by increasing the capacity of the retainer section.

The evaporation source device of the present invention includes a fusion section. Even the retainer section of a small capacity can vaporize stably an evaporation material by continuously refilling an evaporation material in the fusion section. In this case, reducing the capacity of the retainer section results in reducing the energy consumed by the retainer section.

The evaporation source device of the present invention includes a fusion section. Even the retainer section of a small capacity can vaporize stably an evaporation material by continuously refilling an evaporation material in the fusion section. In this case, reducing the capacity of the retainer section results in reducing the energy consumed by the retainer section.

The evaporation source device of the present invention includes an ejector section. The ejector portion has a large number of nozzles or slits so that the vapor ejection amount of an evaporation material can be increased. When the heating temperature of the evaporator section and the evaporation area of the evaporation material are constant, the evaporation amount (or the generated vapor amount) of an evaporation material becomes constant so that the dynamic equilibrium state is maintained. The generated vapor is emitted from the nozzle or slit while part thereof is condensed to liquid. The total amount of the generated vapor is equal to the total amount of the ejected vapor and the condensed vapor. That is, arranging many nozzles or slits in the ejector section leads to increasing the amount of ejected vapor but the amount of condensed vapor decreases. As a result, the amount of generated vapor becomes constant (phenomenon (behavior) under a saturated vapor pressure). Therefore, even if the number of nozzles or slits in the ejector section is increased to increase the amount of ejected vapor, the vapor amount of the evaporation material is constant. Hence, the heat energy required for evaporation of an evaporation material is not changed even if the amount of ejected vapor is increased. As a result, vapor deposition can be stably performed onto a large substrate for a long time with a small amount of energy.

In the evaporation source device of the present invention, a descending column is disposed in the cylindrical heater of the evaporator section. Thus, the rate at which a molten evaporation material descends inside the cylindrical heater can be slowed, compared with the case where the descending column is not disposed. Since the slowed descending rate prolongs the time period for which an evaporation material is exposed to the radiation heat, the cylindrical heater can be shortened in length. Unevenness or grooves formed on the surface of the descending column can further prolong the descending time of an evaporation material and the wet area can be increased. Therefore, the descending amount and the evaporation amount of an evaporation material can be increased.

The descending column, which is three dimensional, can be formed so as to have its large evaporation surface area and can reduce the installation space, compared with the flat evaporation source device. In the case of the flat evaporation source device, a circular evaporation surface having a diameter of 50 cm, for example, has an evaporation surface area of about 1,962 cm². In the case of the cylindrical descending column having, for example, a height of 40 cm, the diameter by which the evaporation surface area is equivalent to that of the flat evaporation source is about 16 cm.

In the evaporation source device of the present invention, an ejection opening such as a nozzle can be formed at an arbitrary position on a peripheral surface, which includes the bottom surface of the cylindrical heater in the evaporator section or ejector section. Hence, the installation place for a substrate can be selected arbitrarily. The freedom degree in design of an evaporator device becomes large. Moreover, the ejection opening can be formed in two or more directions.

One goal of most physical vacuum deposition apparatuses being currently used is to supply continuously a solid evaporation material for a long time deposition. However, refilling a solid evaporation material into the evaporation source device causes a decrease of temperature, thus obstructing stable deposition. However, in the evaporator section of the evaporation source device of the present invention, the refilling opening, which refills a solid evaporation material, is formed so as to confront the opening through which a molten evaporation material descends. Thus, a temperature change involved in a supply of an evaporation material can be prevented. Moreover, the temperature change can be more prevented by disposing the fusion section. Therefore, the evaporation source device of the present invention can perform stable vapor deposition while a solid evaporation material is being continuously supplied.

In the evaporation source device of the present invention, the descending opening of the heater vessel in the retainer section can be arbitrarily adjusted from a sealed state to a full open state, so that the opening area of the descending opening can be adjusted. The evaporation amount of an evaporation material can be easily adjusted. Therefore, the evaporation requirements can be adjusted independently of the temperature. With the descending opening completely sealed, after energization to each portion for heating is cut, deposition can be resumed. Therefore, although the evaporation source device of the present invention is an enclosed-type evaporation device, it can be operated in a manner similar to the open-type evaporation source device. This evaporation source device eliminates the troublesome works such as disassembly of a crucible, supply of an evaporation material, or assembly of a crucible, which is required in the conventional sealed-type evaporation source device.

In the evaporation source device of the present invention, the fusion section can prevent undesired gases from intruding into the evaporator section. Usually, when an evaporation material is heated, unnecessary gases are emitted. However, in the evaporation source device of the present invention, since unnecessary gases are removed when a solid evaporation material melts in the fusion section, the unnecessary gases do not intrude into the evaporator section.

The evaporation source device of the present invention can foster practical applications of the cluster ion beam (ICO) technique. That is, the cluster ion beam technique is known as the technique of controlling the function of ions in a wide range and thus obtaining a desired vapor growth film. However, since the cluster ion beam technique requires using the enclosed-type evaporation source device, the practical use has not progressed. However, using the evaporation source device of the present invention allows the practical use of the cluster ion beam technique to be progressed.

In the evaporation source device of the present invention, a rotatable descending column can cancel and reduce variations in flow of an evaporation material.

The evaporation source device of the present invention includes an adjuster which adjusts the opening area of the descending opening to control the amount of a liquid evaporation material descending into the evaporator section. Thus, the evaporation amount of an evaporation material can be adjusted.

In the evaporation source device of the present invention, the head of the descending column, which is flat or recessed, allows increasing the falling area of an evaporation material. Moreover, even if the length over which an evaporation material falls is not long, the time for which the molten evaporation material is vaporized can be shortened.

In the evaporation source device of the present invention, the descending column has the surface on which a helical groove is formed and the upper end of the helical groove protrudes from the head of the descending column. Thus, the direction in which a molten evaporation material flows out of the recessed portion of the descending column can be regulated.

In the evaporation source device of the present invention, the descending column has the surface on which a helical groove formed of a crest and a root is formed. A convex portion is formed on the upper surface of the crest to define a flow channel of an evaporation material. Thus, the flow of an evaporation material can be regulated.

### BRIEF DESCRIPTION OF THE DRAWINGS

FIG. 1 is a cross-sectional view illustrating an evaporation source device according to a first embodiment of the present invention;

FIG. 2 is a cross-sectional view illustrating an evaporation source device according to a second embodiment of the present invention;

FIG. 3 is a view illustrating a surface example of the descending column of FIG. 2 according to a third embodiment of the present invention;

FIG. 4 is a view illustrating a surface example of the descending column of FIGS. 2 and 3 according to a forth embodiment of the present invention;

FIG. 5 is a view illustrating the surface example of the descending column shown in FIG. 2 according to a fifth embodiment of the present invention;

FIG. 6 is a cross-sectional view illustrating an evaporation source device according to a sixth embodiment of the present invention;

FIG. 7 is a view illustrating the ejection opening in the ejector portion of FIG. 6 according to a seventh embodiment of the present invention;

FIG. 8 is a cross sectional view illustrating an evaporation source device according to a eighth embodiment of the present invention;

FIG. 9 is a cross sectional view illustrating an evaporation source device according to a ninth embodiment of the present invention;

FIG. 10 is a cross sectional view illustrating an evaporation source device according to a tenth embodiment of the present invention;

FIG. 11 is a cross sectional view illustrating the entire configuration of an evaporation source device according to a eleventh embodiment of the present invention;

FIG. 12 is a cross sectional view illustrating an evaporation source device of a twelfth embodiment of the present invention;

FIG. 13 is a cross sectional view illustrating an evaporation source device of a thirteenth embodiment of the present invention;

FIG. 14 is a diagram illustrating rotation of the descending column of FIG. 12 according to a fourteenth embodiment of the present invention;

FIG. 15 is a cross sectional view illustrating an evaporation source device according to a fifteenth embodiment of the present invention;

FIG. 16 is a view illustrating the shape of the descending column of FIG. 15 according to a sixteenth embodiment of the present invention;

FIG. 17 is a view schematically illustrating a conventional vacuum evaporator; and

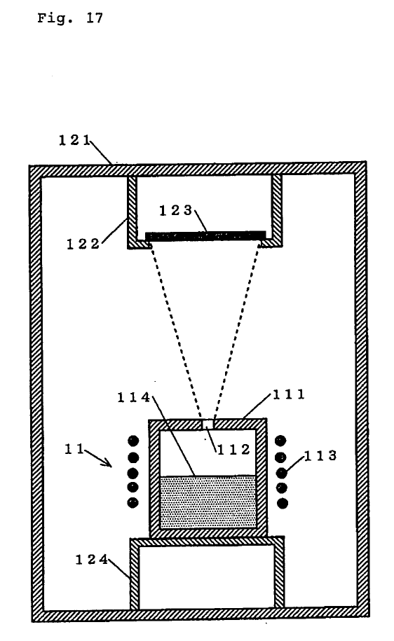

FIG. 18 is a cross sectional view illustrating a crucible mounted on a conventional vacuum deposition apparatus.

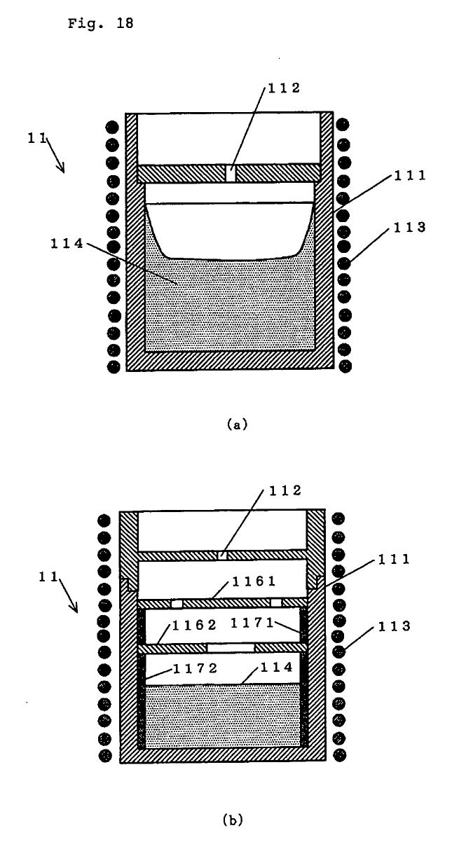

### BEST MODE FOR CARRYING OUT THE INVENTION

An evaporation source device according to the present invention can be divided into two or more temperature control areas. The evaporation source device is roughly divided into two temperature control areas. One temperature control area is an area (retainer section) for storing and retaining a molten evaporation material or an area (retainer section) for melting a solid evaporation material, and storing and retaining a molten evaporation material. The other temperature control area is an area (evaporator section) for vaporizing a molten evaporation material. Moreover, the evaporation source device has an area (ejector section) for ejecting vapor and an area (melting section) for melting a solid evaporation material.

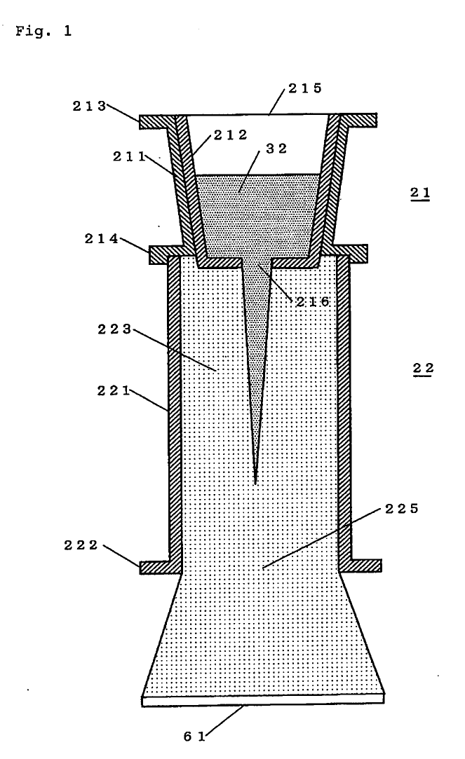

By referring to FIGS. 1 to 11, evaporation source devices according to embodiments of the present invention will be explained. In FIGS. 1 to 11, like reference numerals are attached to the same constituent elements.

### Embodiment 1

FIG. 1 is a cross sectional view illustrating an evaporation source device according to a first embodiment.

A crucible is heated in a resistance heating method. Other heating methods such as electron bombardment may be employed.

The evaporation source device comprises a retainer section 21 for storing and retaining a melted/liquefied evaporation material, an evaporator section 22 for heating a melted/liquefied evaporation material to a vaporizable temperature and vaporizing it, and an ejection opening 225 for ejecting vapor onto a substrate 61.

The retainer section 21 is formed of a cylindrical heater 211, which can be energized electrically and a heating vessel or cavity 212, made of an electric insulator, which is accommodated in the cylindrical heater 211. In the retainer section 21 shown in FIG. 1, it is assumed that a molten evaporation material 32 is a conductive material. However, when the molten evaporation material 32 is an electric insulator, only the cylindrical heater 211 may be used.

The cylindrical heater 211 includes electrodes 213 and 214. When a voltage is applied between both the electrodes, the cylindrical heater 211 generates heat with the current flowing through it. The material for the cylindrical heater 211 is graphite.

The heating vessel 212 rises its temperature with the conduction heat of the cylindrical heater 211 and maintains the inside of the evaporation material 32 in a constant melting state. Ceramic is used for the heating vessel 212.

The cylindrical heater 211 has an upper portion in which a refilling opening 215 is formed for refilling an evaporation material. The evaporation material is refilled or supplied continuously or intermittently from the refilling opening 215 and an evaporation material 32 in molten state of a constant amount is always stored and retained in the heating vessel 212. Since the temperature of the evaporation material 32 in molten state varies largely the viscosity of the evaporation material 32, the evaporation material 32 is maintained at a temperature which sustains the viscosity in a predetermined range.

The heating vessel 212 has the lower portion (bottom portion) in which a descending opening 216 for descending a molten evaporation material 32 is formed. A constant amount of the evaporation material 21 in the heating vessel 212 always drops from the descending opening 216 into the evaporator section 22 by gravity. The descent amount depends on the size of the descending opening 216. However, since the viscosity changes with temperature and the surface tension exists, the size of the descending opening 216 is determined for a predetermined descent amount, by considering the two factors. Moreover, the descending opening 216 is considered such that the descending evaporation material 32 is in no contact with the inner wall surface of the cylindrical heater 221.

The evaporator section 22 is formed of a cylindrical heater 221, which can be energized electrically, and an ejection opening 225. The cylindrical heater 221 includes an electrode 214 (shared with the electrode of the cylindrical heater 211) and 222. When a voltage is applied between the two electrodes, the cylindrical heater 221 is heated with the current flowing through the cylindrical heater 221. The cylindrical heater 221 is made of graphite.

The current flowing through the cylindrical heater 211 in the retainer section 21 and the current flowing through the cylindrical heater 221 in the evaporator section 22 can be controlled respectively. The temperature of the retainer section 21 is set to a temperature at which the evaporation material 32 can be maintained in its molten state. The temperature of the evaporator section 22 is set to a temperature at which the evaporation material 32 can be vaporized.

The evaporation material 32 in the heating vessel 212 descends from the descending opening 216 into the cylindrical heater 221. At this time, when the temperature of the cylindrical heater 221 does not reach the evaporation temperature of the evaporation material 32, the cross section in horizontal direction (perpendicular to the descending direction) of the evaporation material 21 during descending becomes a cylindrical column due to viscosity and surface tension. However, when the temperature in the cylindrical heater 221 reaches the evaporation temperature of the evaporation material 32, the evaporation material 32 in the cylindrical heater 221 begins instantaneously to vaporize form its surface due to the radiation heat from the cylindrical heater 221. Thus the cross section gradually slenderized in an inverted conical shape. The evaporated vapor is filled in the evaporation space 223. In this process, since the evaporation material 32 in molten state maintains its sensible heat even at an evaporable high temperature, the evaporation material 32 descending the cylindrical heater 221 does not vaporize. A dynamic equilibrium state between vaporization and re-liquefaction occurs in the cylindrical heater 221. The height of the cylindrical heater 221 is set to the height in which the evaporation material 32 is vaporized completely before reaching the ejection opening 225. In this case, if both the descending opening 216 and the descent amount of the evaporation material 32 are small, the height of the cylindrical heater 221 becomes low.

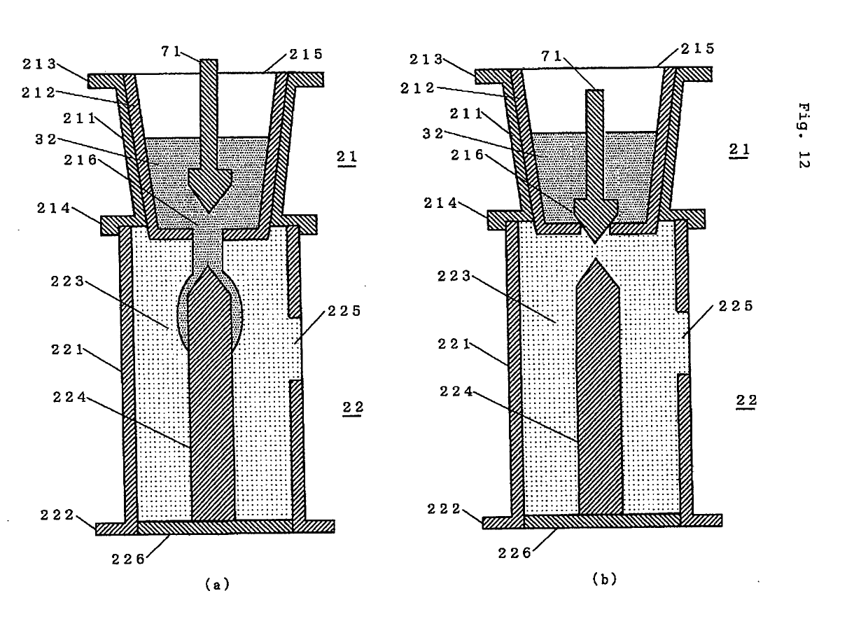

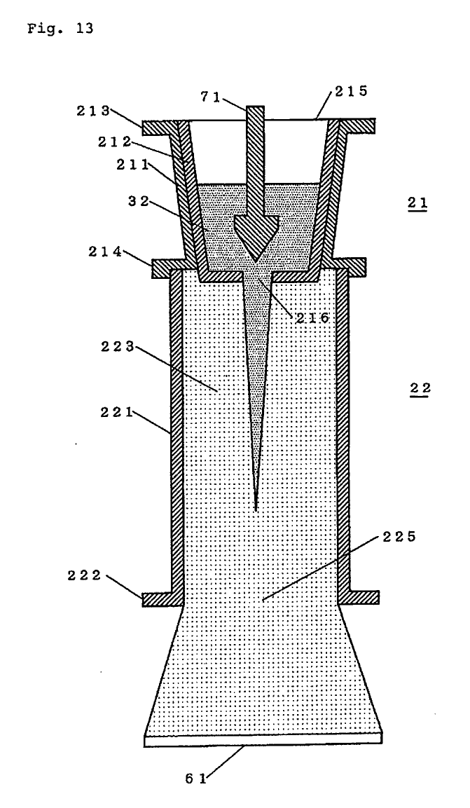

Since the generated vapor is ejected from the ejection opening 225 onto the substrate 61, the substrate 61 is placed beneath the ejection opening 225. With the ejection opening 225 (shown in FIG. 1) closed but disposed on the side surface of the cylindrical heater 221 (to be disclosed later), the substrate 61 may be disposed upright. Such an upright structure cannot be realized by the conventional enclosed-type evaporation source device and the open-type evaporation source device shown in FIG. 12 and in FIG. 13.

Here, explanation is made as to refilling an evaporation material.

Since the evaporation material 32, being melted inside the heating cavity 212 in the retainer section 21, decreases with the evaporation material 32 in molten state descending toward the cylindrical heater 221 in the evaporator section 22, it is desirable to refill the amount corresponding to the reduced amount. When the molten evaporation material 32 is not supplied, the temperature of the cylindrical heater 211 in the retainer section 21 rises gradually if the supplied electric power is constant. For that reason, the molten evaporation material 32 decreases its viscosity and speeds up its descending rate. As a result, the molten evaporation material 32 is canceled with the reduced influence of gravity but increases its descent amount. Therefore, in order to maintain to a constant value the amount of the evaporation material 32, which falls down from the heating vessel 212 to the cylindrical heater 221, it is necessary to supply the reduced amount of the evaporation material. Thus, the evaporation material 32 retained in the heating vessel 212 is maintained to a constant value.

When deposition is carried out over the consumption of the evaporation material 32 retaining in the heating vessel 212 in the retainer section 21 or when the evaporation material 32 exceeding the volume of the heating vessel 212 is required, it is required to supply the evaporation material 32 in the heating vessel during evaporation.

The temperature of the heating vessel 212 is influenced by the temperature of the supplied evaporation material. However, the descending opening 216, in FIG. 1, is disposed at the position opposite to the refilling opening 215. Hence, the heating vessel 216 is positioned at the place where it is difficult to be subjected to the temperature of the supplied evaporation material. However, even when the refilling opening 215 is placed direct oppositely to the descending opening 216, the heating vessel 212 of a small volume is delicately subjected to the temperature of a refilled material, thus decreasing its temperature. As a result, the descent amount of the evaporation material 32, which descends from the heating vessel 212 to the cylindrical heater 221, decreases so that the evaporation amount is decreased. Increasing the volume of the heating vessel 212 leads to decreasing a drop of temperature due to the supply of an evaporation material. In that case, the solid evaporation material can be directly supplied from the refilling opening 215 to the heating vessel 212. Alternatively, the influence due to the temperature fall can be reduced by disposing the refilling opening 215 as far as possible from the descending opening 216.

Moreover, temperature detection means such as thermocouple may be disposed at a predetermined position of the retainer section 21. The electric power supplied to the heating cavity 212 may be controlled based on the temperature detected by the temperature detection means. Thus, even when a solid evaporation material 32 is refilled in the heating vessel 212, it can be maintained at a nearly constant temperature. Moreover, the evaporation amount stabilized for long time can be obtained in the evaporator section 22.

### Embodiment 2

Referring to FIG. 1, the descending rate, at which the evaporation material 32 descends in the cylindrical heater 221, is determined by the viscosity of the evaporation material 32 and the gravity. Hence, when the descent amount of the evaporation material 32 is increased to increase the evaporation amount of the evaporation material 32, the descent time prolongs, which is taken till the evaporation material 32 is completely vaporized. It is required to extend vertically the cylindrical heater 221 to prolong the descent time. For that reason, in order to manufacture and handle easily the evaporation source device, it is demanded to prolong the descent time of the evaporation material 32, without vertically extending the cylindrical heater 221

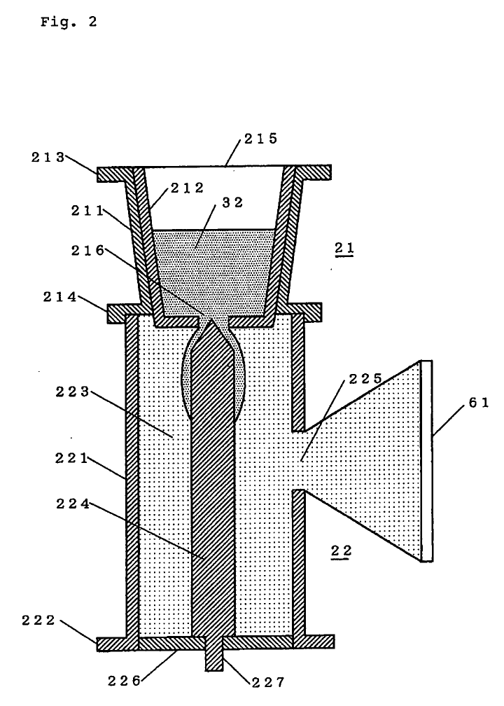

In order to respond the demand, the evaporation source device, shown in FIG. 2, has means for slowing the descending time of the evaporation material 32.

In the evaporation source device of FIG. 2, a descending column 224 is disposed in the cylindrical heater 221. The bottom of the cylindrical column 221 is closed with the bottom member 226. An ejection opening 225 is formed on the side surface of the cylindrical heater 221. A vertically movable shaft 227 of the descending column 224 is fitted into the bottom member 226.

The descending column 224 is disposed such that the outer wall surface thereof does not contact with the inner wall surface of the cylindrical heater 221. Preferably, the distance between the inner wall surface of the cylindrical heater 21 and the peripheral surface of the descending column 224 is equal in all directions from the vertical surface of the descending column 224. The radiation heat from the cylindrical heater 221 reaches evenly to the peripheral surface of the descending column 224.

The tip of the descending column 224 is adjacent to the descending opening 216 and contacts with the evaporation material 32 running down from the descending opening 216. The tip of the descending column 224 may protrude within the heating cavity 212. The descending column 224 is made of alumina or ceramic.

The evaporation material 32 flowing from the descending opening 216 of the heating cavity 212 runs down along the surface of the descending column 224. Since the descending rate of the evaporation material 32 is regulated by the contact resistance on the surface of the descending column 224, it becomes slow, compared with the evaporation material 32 falling down in the space. Moreover, since the evaporation material 32 diffuses onto the surface of the descending column 224, a large radiation heat receiving area is obtained, thus facilitating evaporation. The surface temperature of the descending column 224 corresponds to the temperature that the evaporation material 32 can maintain its melting state.

### Embodiment 3

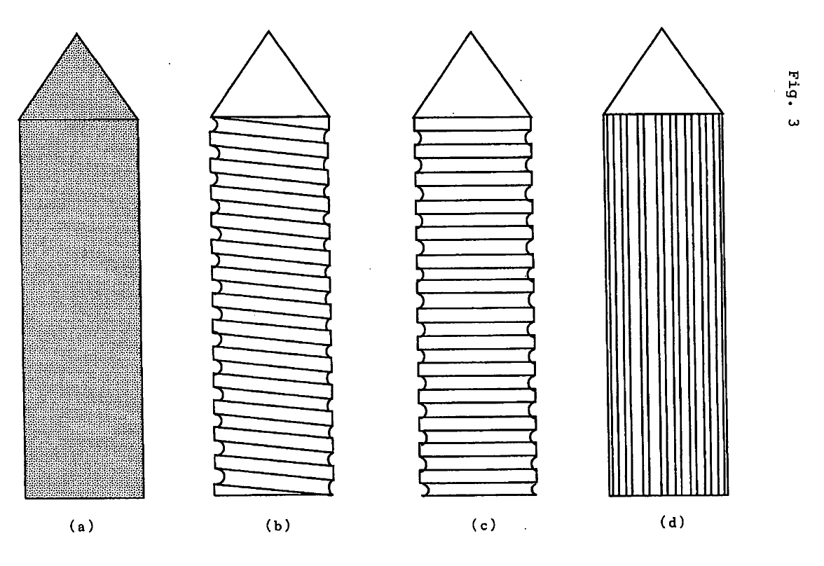

FIG. 3 shows an embodiment of the descending column 224 of FIG. 2. FIG. 3 shows four types of surface shape of the descending column. In the descending column, the surface shape determines the descent rate or wet area (diffusion area) of a molten evaporation material.

In FIG. 3(a), the descending column has a small rough surface or a pear-skin surface. In FIG. 3(b), the descending column has helical grooves on the surface thereof. In FIG. 3(c), he descending column has horizontal ring-like grooves on the surface thereof. In FIG. 3(d), the descending column has vertical grooves (in the axial direction of the descending column) on the surface thereof.

In the descending columns shown in FIGS. 3(a) to 3(c), the rough surface works to slow down the descending rate of an evaporation material. The large wet area can increase the effect of radiation heat to an evaporation material. The descending column may have different rough surfaces, without being limited to the above examples.

Different evaporation materials have a different viscosity in molten state and a different evaporation time. The surface shape may be suitably selected according to kinds of evaporation material.

In explanation, the head of the descending column of FIG. 3 has a conical shape. However, the head of the descending column may be hemispherical or flat.

### Embodiment 4

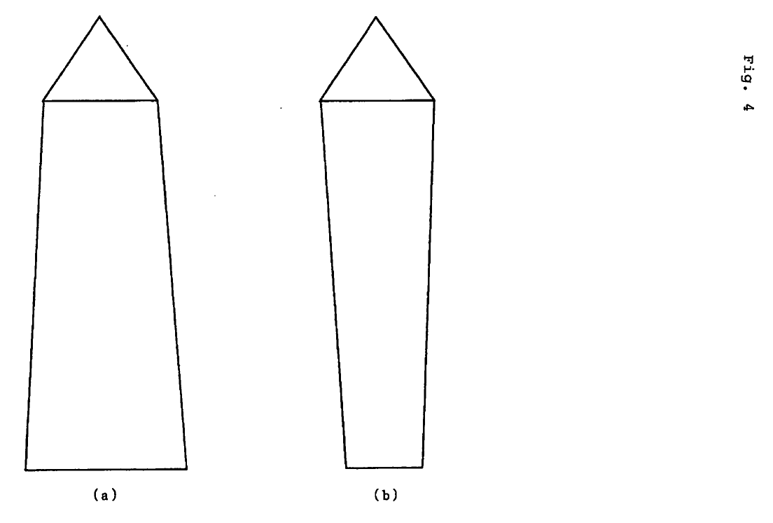

FIG. 4 shows embodiments of the descending columns in FIGS. 3 and 4.

In the descending columns shown in FIGS. 2 and 3, the main body, except the head (tip), has a cylindrical shape. However, in the descending column of FIG. 4, the main body has a nearly erect conical shape or a nearly inverted conical shape.

FIG. 4(a) shows an example of a descending column having an erect conical shape. FIG. 4(b) shows an example of a descending column having an inverted conical shape. The descending column of FIG. 4(a) has a larger diffusion area (wet area) toward the lower portion thereof. The molten evaporation material is thinned in the descending direction and the radiation heat receiving area is increased. The descending column of FIG. 4(b) has a smaller diffusion area (wet area) toward the lower portion thereof. The molten evaporation material is tapered in the descending direction. However, as the evaporation material descends, it vaporizes. Since the remaining amount of an evaporation material decreases, the film is not thickened.

### Embodiment 5

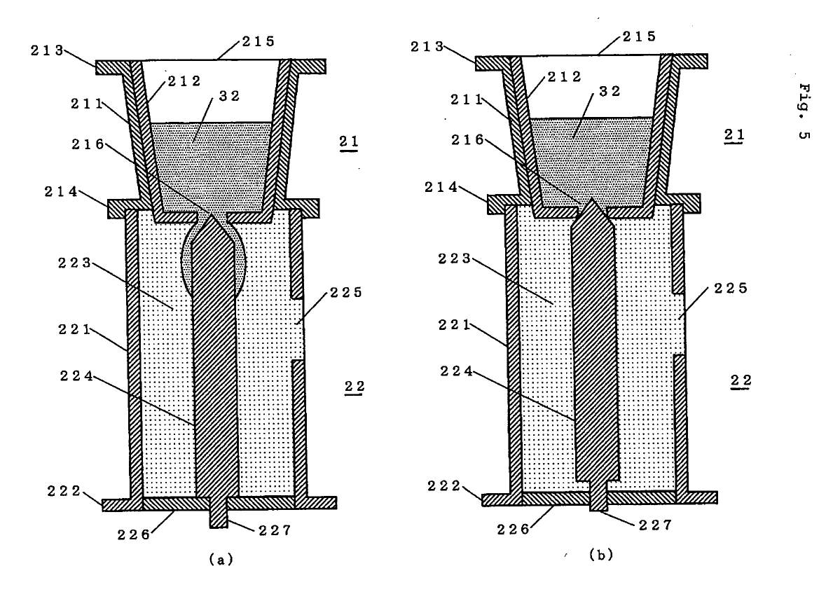

FIG. 5 shows an example of the descending column 224 of FIG. 2 moving vertically.

FIG. 5(a) shows the descending column 224 rested on the lowermost portion. FIG. 5(b) shows the descending column 224 lifted to the uppermost portion.

In FIG. 5(a), the molten evaporation material 32 flows out from the descending opening 216 of the heating vessel 212 and then runs down along the surface of the descending column 224. In FIG. 5(b), the tip of the descending column 224 clogs the descending opening 216 to prevent the molten evaporation material 32 from flowing out from the descending opening 216. By controlling the descending opening 216 vertically moving between positions shown in FIGS. 5(a) and 5(b), the amount of the molten evaporation material 32 which flows from the heating vessel 212 to the cylindrical heater 221 can be adjusted. By adjusting the inlet amount of the molten evaporation material 32, the evaporation amount of the evaporation material 32 can be adjusted.

The descending column 224 can be moved by combing the vertically movable shaft 227 with a drive mechanism (not shown), such as a combination of a warm and a warm gear, a screw mechanism, or a cam mechanism.

The tip of the descending column may be hemispherical or flat, as described above.

### Embodiment 6

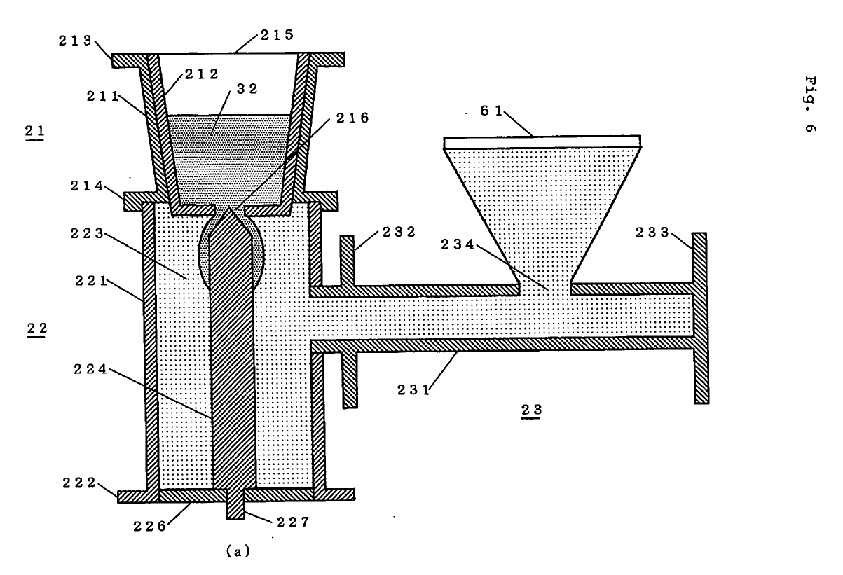

FIG. 6 shows an embodiment of the evaporation source device in which an ejector section is formed on the side surface of the evaporator section 22 in FIG. 2.

In the evaporation source device of FIG. 6, a horizontal ejector section 23 is attached on the side surface of the cylindrical heater 221.

The ejection section 23 is formed of a cylindrical heater 231, which can be energized electrically, and an ejection opening 234. The cylindrical heater 231 has electrodes 232 and 233. When a voltage is applied between the electrodes, the cylindrical heater 231 generates heat by current. In the ejector section 23, the heating temperature can be controlled independently of the retainer section 21 and the evaporator section 22. Hence, the temperature of the cylindrical heater 231 can be independently set to a predetermined value. The cylindrical heater 231 is made of graphite.

The vapor of an evaporation material filled in the vapor space 223 of the evaporator section 22 moves toward the cylindrical heater 231 and ejects from the cylindrical opening 234 onto the substrate 61.

The ejection opening 234 in FIG. 6 directs immediately above the cylindrical heater 231 (or in the upper direction perpendicular to the axis of the cylindrical heater 231). However, the ejection opening 234 may direct immediately below, obliquely upward or obliquely downward the cylindrical heater 231. That is, in the case of FIG. 6, since the ejection opening 234 can be directed all in the directions from the periphery of the cylindrical heater 231, the substrate 61 can be disposed at an arbitrary place.

### Embodiment 7

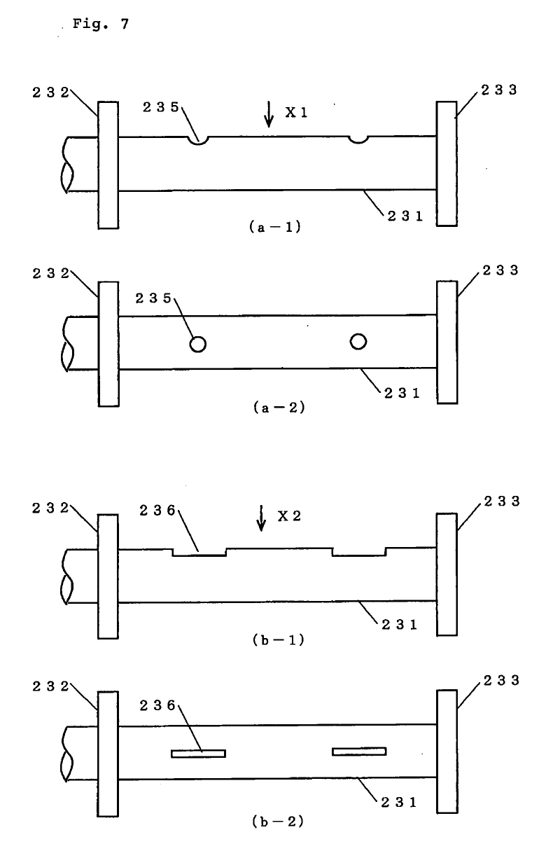

FIG. 7 shows the ejection opening of the cylindrical heater 231 in the ejector section 23 shown in FIG. 6.

Each of FIGS. 7(a-1) and 7(a-2) shows an example of the cylindrical heater 231 having two nozzles 235. FIG. 7(a-2) is a plan view illustrating the structure seen from the X1-direction in FIG. 7(a-1).

Each of FIGS. 7(b-1) and 7(b-2) shows an example of the cylindrical heater 231 having two slits 236. FIG. 7(b-2) is a plan view illustrating the structure seen from the X2-direction in FIG. 7(b-1).

As to the ejection opening, the nozzle 235 or slit 236 is selected by considering the vapor ejection amount of an evaporation material and easiness of machining. The number of the nozzles 235 or slits 236 is selected by considering the total ejection amount of vapor ejected onto the substrate, without being limited to two. This consideration is applicable to the determination of the opening area of the nozzle 235 or slit 236. Referring to FIG. 7, the nozzles 235 or slits 236 are formed in parallel in the axial direction of the cylindrical heater 231. However, the nozzles 235 or slits 236 may be formed in parallel and perpendicular to the axial direction of the cylindrical heater 231.

When the vapor amount in the evaporator section 22 in FIG. 6 can be obtained sufficiently, the cylindrical heater 231 is extended to form a number of nozzles or slits 236.

### Embodiment 8

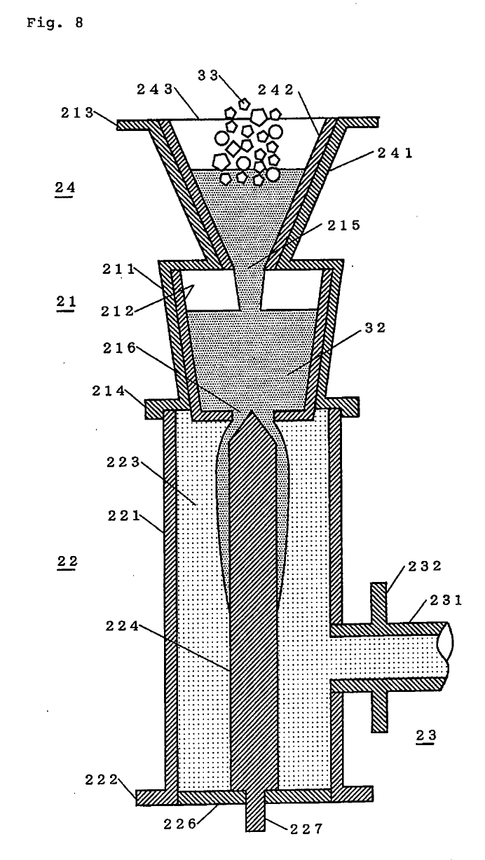

FIG. 8 shows an embodiment of an evaporation source device having a fusion section for grain or powder evaporation materials. In the evaporation source device of FIG. 8, the fusion section 24 is disposed over the retainer section 21.

The fusion section 24 has the upper wide portion and the lower narrow portion (or a funnel-shaped structure) and is coupled to the heating vessel 212 in the retainer section 21 via the evaporation material refilling opening 215. The fusion section 24 includes a cylindrical heater 241, which can be energized electrically, and a heating vessel 242 received in the cylindrical heater 241. The cylindrical heater is made of graphite. The heating vessel 242 is made of ceramic. In the retainer section 24 of FIG. 8, it is assumed that the evaporation material 32 in molten is a conductive material. However, when the molten evaporation material 32 is an electric insulator, only the cylindrical heater 241 may be used.

The cylindrical heater 241 in the melting section 24 and the cylindrical heater 211 in the retainer section 21 may be constructed separately or integrally. In either case, the electrodes 213 and 214 are shared by the cylindrical heaters 241 and 211 but may be formed to the cylindrical heaters 241 and 211, respectively.

The heating vessel 242 is heated by the conduction heat from the cylindrical heater 241. In the cylindrical heater 241, since the upper portion is wide and the lower portion is narrow, the lower narrow portion has a large electric resistance and is heated to a higher temperature.

The evaporation material 32 melted in the heating vessel 212 in the retainer section 21 decreases as it descends into the cylindrical heater 221 in the evaporation section 22. Hence, it is desirable to supply an evaporation material corresponding to the reduced amount.

In the evaporation source device shown in FIG. 8, the grain or powder evaporation material 33 is supplied from the refilling opening 234 into the heating vessel 242 and is melted in the heating vessel 242. The molten evaporation material 32 is supplied from the refilling opening 215 into the heating vessel 212. The amount of the evaporation material 33 supplied via the refilling opening 243 is set so as to be substantially equivalent to the amount of the evaporation material 32 reduced in the heating vessel 212.

The temperature of the heating vessel 212 in the retainer section 21 tends to be influenced by the temperature of the evaporation material supplied via the refilling opening 215. However, in the case shown in FIG. 8, since the evaporation material 32 in the heating vessel 212 is supplied in molten state from the heating vessel 242, the temperature of the heating vessel 212 is not influenced by the supply of the evaporation material 33.

### Embodiment 9

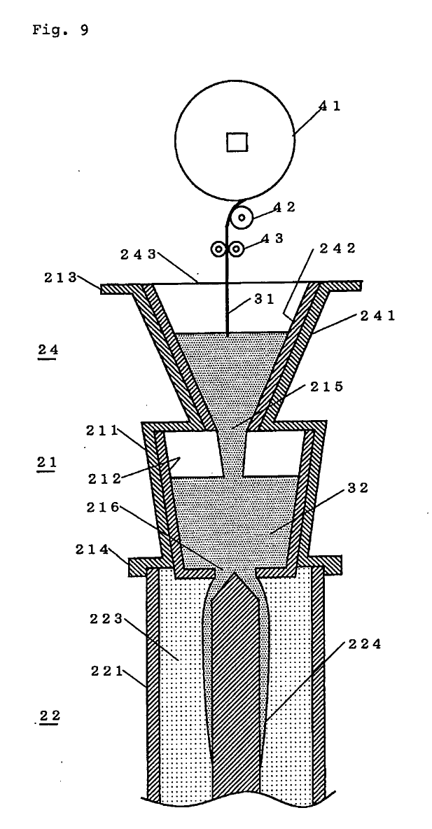

FIG. 9 shows an embodiment of an evaporation source device including a linear or strip evaporation material melting section. In the evaporation source device in FIG. 9, a drum 41 around which copper or strip evaporation material 31 is wound is disposed over the melting section 24. The configuration of the fusion section 24, the retainer section 21 and the evaporator section is the same as that of the evaporation source device in FIG. 8.

The drum 41, which is mounted to a trestle (not shown) which disposed over the fusion section 24, rotates at a predetermined rate by means of drive mechanism (not shown) to unreel the evaporation material 31. The unreeled evaporation material 31 is supplied from the evaporation material refilling opening 243 into the heating vessel 242 via the pulley 42 and the friction gear 43. Thus, when it contacts with the heating vessel 242, the evaporation material 31 melts to an evaporation material in molten phase.

The rate at which the evaporation material 31 is unreeled from the drum 41 is set such that, at an initial stage of deposition, the amount of the molten evaporation material 32 is larger than the amount of the evaporation material which descends into the heating vessel 212. When the heating vessel 242 stores a predetermined amount of the molten evaporation material 32 (or the molten evaporation material reaches a predetermined level), the unreeling rate is set such that the amount of the evaporation material retaining in the heating vessel 242 balances with the amount of evaporation material descending into the heating vessel 212.

### Embodiment 10

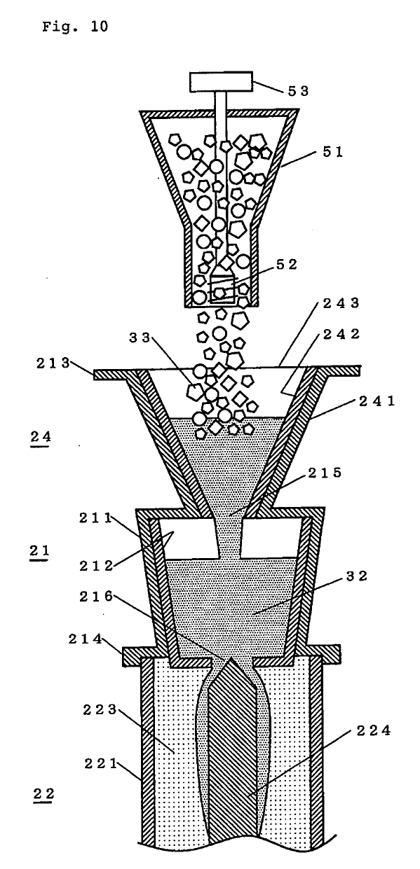

FIG. 10 shows an embodiment of an evaporation source device including a hopper that supplies a copper grain or powder evaporation material in the evaporation source device in FIG. 8.

In the evaporation source device in FIG. 10, a hopper 51 is disposed over the fusion section 54. The configuration of the fusion section 24, the retainer section 21, and the evaporator section 22 is equivalent to that in the evaporation source device in FIG. 8.

The hopper 51 stores a grain or powder evaporation material 33. When the rotating mechanism 53 rotates the screw 52 in the hopper 51 at a predetermined speed, the evaporation material 33 falls down into the heating vessel 51 in the fusion section 242. By varying the rotational speed of the screw 52, the amount of evaporation material 33, which falls down into the heating vessel 242, can be controlled 2.

### Embodiment 11

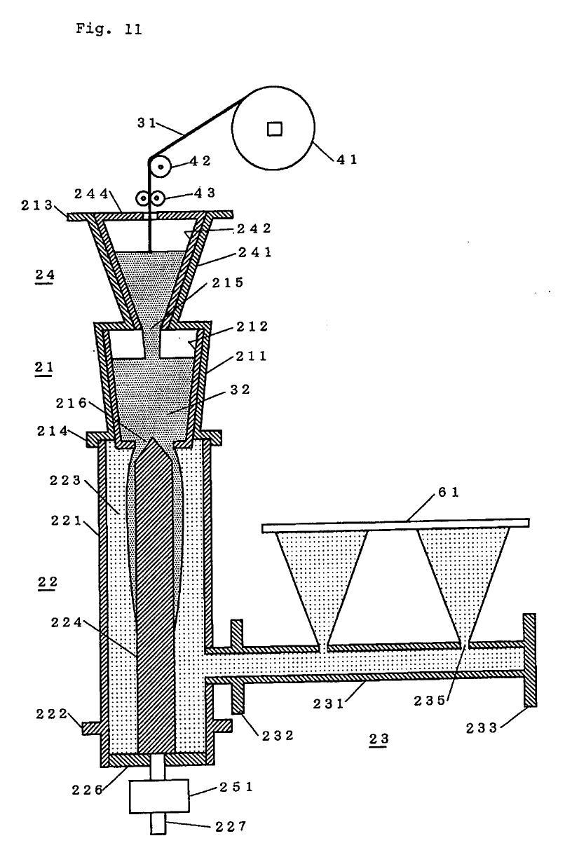

FIG. 11 shows the whole configuration of an evaporation source device according to an embodiment of the present invention. The vacuum chamber (room), the fixing means of the evaporation source device, the thermal shielding means, current supplying means and so on, which are generally required by the vacuum vapor deposition apparatus, are omitted here.

The evaporation source device in FIG. 11 includes a drum 41 around which the evaporation material 31 is wound, a fusion section 24, a retainer section 21, an evaporator section 22, and an ejector section 23. The fusion section 24 communicates with the retainer section 21 via the evaporation material refilling opening 215. The retainer section 21 communicates with the evaporator section 22 via the evaporation material refilling opening 216. The configuration of each section has been explained with the foregoing embodiments.

The cylindrical heaters 241, 211, 221, and 231, which are respectively disposed in the fusion section 24, the retainer section 21, the evaporator section 22, and the ejector section 23 are made of graphite. The evaporation material is heated through resistance heating. Graphite can be easily obtained and machined. The heating vessel 242 in the fusion section 24 as well as the heating vessel 212 in the retainer section 21 are made of ceramic. The descending column 224 in the evaporator section 22 is made of alumina or ceramic. The surface of the descending column 224 has a pear-skin rough surface. The cylindrical heater 231 in the ejector section 23 has two nozzles 235, which sprays a vaporized evaporation material onto the substrate 26.

For example, metals such as silver, aluminum, gold, and copper, mineral materials such as metallic silicon, or organic materials may be used as the linear or ribbon evaporation material 31. Alternatively, grain or powder evaporation materials may be used.

Explanation will be made as to the characteristics of various elements when the evaporation material 31 is copper wire and the operation of the evaporation source device in FIG. 11

Copper has a melting point of 1,084° C. and the temperature at which a pressure of about one torr (133 Pa) is 1,617° C. Alumina or ceramic making the descending column 224 can bear the temperature at which copper evaporates and vaporizes and does not react chemically with copper and is an electric insulator. This feature is suitable as a material for the descending column 224.

The copper wire acting as the evaporation material 31 is unreeled continuously or intermittently from the drum 41 and is supplied to the heating vessel 242 in the fusion section 24.

In the fusion section 24, the retainer section 21, the evaporator section 22, and the ejector section 23, voltages are respectively applied between the electrodes 213 and 214, 214 and 222, and 232 and 233 for the cylindrical heaters 241, 211, 221, and 231. Thus, those cylindrical heaters conduct current and are heated to desired temperatures, respectively. For example, the fusion section 24 and the retainer section 21 are heated at a melting temperature of copper, 1,084° C. The evaporator section 22 and the ejector section 23 are heated at a vaporizing temperature of copper, 1,617° C.

In the deposition operation, the drum 41, around which the evaporation material 31 are previously wound, is loaded on the trestle (not shown). The descending column 224 is lifted to clog the descending opening 216 of the heating vessel 212. Thus, the vacuum chamber (not shown) is evacuated to a predetermined vacuum degree. When the vacuum degree in the vacuum chamber reaches at a predetermined value, the cylindrical heater 241 in the fusion section 24 and the cylindrical heater 211 in the retainer section 21 are energized electrically and heated to predetermined temperatures (a melting point of copper, 1,084° C. or an evaporating point of copper, 1,617° C.). When each section reaches a predetermined temperature, the drum 41 is driven to unreel the evaporation material 31. The melting rate, descending rate, and evaporation rate of the evaporation material 31 are previously checked. In consideration of those factors, the drum 41 is set to a necessary rotational speed at which the evaporation material 31 is unreeled.

The unreeled evaporation material 31 is unreeled into the heating vessel 242 via the opening of the cover 244 of the heating vessel 242 in the fusion section 24 and thus is melted. The melted evaporation material 32 is supplied via the refilling opening 215 to the heating vessel 212 in the retainer section 21 and is retained in the heating vessel 212. When the evaporation material 32 in the heating vessel 212 reaches a predetermined amount, the cylindrical heater 211 in the evaporator section 22 and the cylindrical heater 231 in the ejector section 23 are energized electrically to heat them to an evaporation temperature of copper. Next, the descending column 224 is descended to a predetermined position to open the descending opening 215 of the heating vessel 212. The evaporation material in the heating vessel 212 flows out from the descending opening 215 and runs down along the surface of the descending column 224. On the descending process, the evaporation material 32 is exposed to the radiation heat from the cylindrical heater 221 and evaporates. The vapor space 223 and the cylindrical heater 231 in the ejector section 23 are filled with vapor of the evaporation material 32 and thus the inner pressure increases. Under the sufficiently increased pressure, the vapor of the evaporation material 32 ejects onto the substrate 61 via the nozzles 535. After that, the supply amount of the evaporation material 31 and the evaporation amount of the molten evaporation material 32 are equilibrated, so that vapor can be continuously ejected stably. The vertical driver 251 moves the vertical shaft 227 to move the descending column 224 vertically.

In the present embodiment, vapor can be continuously ejected in that state without splashing. Unnecessary gases generated from the evaporation material 31 are removed in the fusion section 24 so that they do not exist in the vapor ejected from the nozzles 235.

In order to cease deposition, the unreeling the evaporation material 31 out of the drum 41 is first stopped. By doing so, the molten evaporation material 32 does not exist in or remains slightly in the fusion section 24 and the retainer section 21. Damages of the system can be prevented caused by different thermal contraction due to the temperature drop. In succession, the descending column 224 is lifted to close the descending opening 216 in the heating vessel 212. When heating continues for a predetermined time (for example, 20 seconds) in such a state, the evaporation material 32 left in the evaporator section 22 is completely ejected out. This feature can prevent damage due to the different thermal contraction, as described above. After that, electric energization to each cylindrical heater is cut.

In order resume the next deposition process, the amount of an evaporation material 32 remaining on the drum 41 is checked and, if necessary, a new evaporation material is loaded to resume the next procedure.

In the evaporation source device according to the present embodiment, like the conventional enclosed-type evaporation source device shown in FIGS. 12 and 13, when the evaporation material is refilled, it is not required that the crucible is disassembled and then re-assembled. For that reason, the initial setup of the deposition work is simplified and is finished for a short time. Moreover, the evaporation source device of the present invention can provide an extremely large amount of an evaporation material vapor and can supply the evaporation material continuously, thus performing a large volume of deposition at high rate. By preparing plural evaporation source device shown in FIG. 11, a larger volume, high-rate deposition can be performed.

In the evaporation source device of the present embodiment, the evaporation material 32 in the evaporator section 22 descends along the surface of the descending column 224, without contacting to the inner surface of the cylindrical heater 221. Hence, the evaporation material 32 is not directly heated by the cylindrical heater 221 (or due to the conduction heat), but is heated by the radiation heat. The evaporation material 32 descends in the film form formed over the surface of the descending column 224. Therefore, the evaporation material 32 descending along the surface of the descending column 224 is not heated locally and drastically but is heated and evaporated and emitted uniformly from the surface thereof into the evaporation space 223. Therefore, when the evaporation material 32 evaporates, it does not occur that some thereof spatters in a liquid phase into the evaporation space 223 or the so-called splash does not occur.

Because the evaporation material 32 in the evaporator section 22 spreads and descends over the surface of the descending column 224, the surface area for evaporation becomes large and the descending rate becomes slow. Hence, the evaporation amount is large. Moreover, the slow descending rate of the evaporation material 32 allows the cylindrical heater 221 to be shortened, thus resulting in a miniaturization of the evaporation source device.

### Embodiment 12

FIG. 12 is a cross-sectional view illustrating an evaporation source device having in the retainer an adjuster that adjusts the opening area of the descending opening, in place of the descending column shown in FIG. 2.

FIG. 12(a) shows an adjuster which is lifted to the highest level and FIG. 12(b) shows an adjuster which is descended to the lowest level.

In the evaporation source device in FIG. 12, an opening/closing adjusting valve (adjuster) 71, which confronts the descending column 224 via the descending opening 216, is disposed in the retainer section 21. The descending column 224 is securely fixed on the bottom member 226. For the opening/closing adjusting valve 71, a material, which does not react to a molten material but which bears the melting temperature, is selected. If the molten material is, for example, copper, alumina can be used. The opening/closing adjusting valve 71 has the size and shape which can block or clog the descending opening 216. The opening/closing adjusting valve 71 can close or narrow the descending opening 216 and moves vertically to adjust the opening area of the descending opening 216.

In the case shown in FIG. 12(a), the molten evaporation material 32 flows out from the descending opening 216 in the heating section 212 and runs down along the surface of the descending column 224. In the case shown in FIG. 12(b), the tip of the opening/closing adjusting valve 71 clogs the descending opening 216. Thus, the opening/closing adjusting valve 71 prevents the molten evaporation material 32 from flowing down out of, for example, the descending opening 216. The opening/closing adjusting valve 71 can be adjusted vertically between the position shown in FIG. 12(a) and the position shown in FIG. 12(b). By adjusting the amount that the molten evaporation material 32 runs from the heating vessel 22 to the cylindrical heater 221, the evaporation amount of the evaporation material 32 can be controlled.

The opening/closing adjusting valve 71 can be vertically moved, with the other end combined with drive mechanism (not shown) such as a worm and worm gear, screw mechanism, or cam mechanism.

The example that the opening/closing adjusting valve 71 has a conical tip has been explained. However, a hemispherical or flat tip may be used.

In FIG. 12(a), the example is shown that the upper limit at which the opening/closing adjusting valve 71 travels is in the retainer section 21. However, the upper limit may be inside or outside the evaporation material 32 of the retainer 21.

### Embodiment 13

FIG. 13 shows an embodiment of an evaporation source device that includes an adjuster for adjusting the opening area of the descending column in the retainer section shown in FIG. 1.

In the evaporation source device of FIG. 13, an opening/closing valve (adjuster) 71 confronting the descending opening 216 is disposed in the retainer section 21.

By varying the position where the opening/closing adjusting valve 71 vertically travels, the amount that the molten evaporation material flows down from the heating vessel 212 to the cylindrical column 221 can be adjusted. By adjusting the inlet flow of the molten evaporation material, the evaporation amount of the evaporation material 32 can be adjusted.

### Embodiment 14

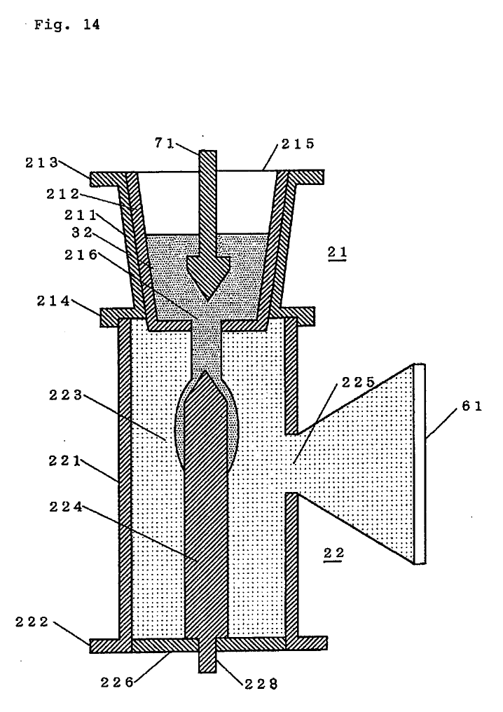

FIG. 14 shows an embodiment of an evaporation source device that has the descending column of FIG. 1, which is rotated.

In the evaporation source device of FIG. 14, a rotational shaft 228 is attached to the descending column 224. The rotational shaft 228 is fitted into the bottom member 226.

The descending column 224 can be rotated with a drive mechanism (not shown).

In FIG. 14, the molten evaporation material 32 flows out of the descending opening 216 in the heating vessel 212 and runs down along the surface of the descending column 224. In this case, by rotating slowly the descending column 224 by 360 degrees, variations in flow of the evaporation material 32 can be canceled or reduced even if the center axis of the descending column 224 is not aligned to or is tilted from the center axis of the descending opening 216. The rotational speed of the descending column 224 must be suppressed to a small value such that the evaporation material 32 is not separated from the surface thereof by centrifugal force.

The descending column 224 in other embodiments can be rotated in addition to vertical movement.

### Embodiment 15

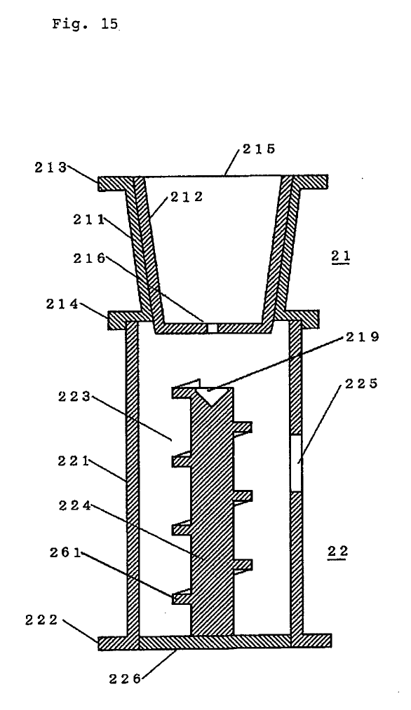

FIG. 15 is a cross sectional view illustrating an evaporation source device that includes another descending column, in place of the descending column shown in FIG. 2. In FIG. 15, the molten evaporation material 32 and the generated vapor are not illustrated. The descending column 224 is fixed on the bottom member 226.

In the evaporation source device of FIG. 15, a helical groove (protrusion) 261 is formed on the surface of the descending column 224. The helical groove has crests and roots, formed on the surface of the descending column 224. The crest is illustrated as the helical groove 261. Moreover, the head of the descending column 224 is concave (recessed). That is, the head of the descending column 224 has a concave (retainer portion) 219. The concave 219 confronts the descending opening 216. The upper end of the helical groove 261 on the surface of the descending column 224 protrudes toward the descending opening 216 from the head of the descending column 224.

In FIG. 15, the molten evaporation material flows down from the descending opening 216 in the heating vessel 212 and is retained in the recess 219 of the head of the descending column 224. When the retained evaporation material occupies the recess 219, it overflows out. By adjusting the inlet flow of the evaporation material, the evaporation material descends along the helical groove 261 on the surface of the descending column 224.

In FIG. 15, since the helical grove 261 on the descending column 224 protrudes toward the descending opening 216 from the head of the descending column 224, the direction in which the molten evaporation material flows out from the recess 219 of the descending column 224 can be regulated.

In place of the protruding head of the helical groove 261, part (outer periphery) of the recess 219 in the descending column 224 may be cut such that the molten evaporation material flows out from the cut portion. Thus, the direction, in which the molten material flows out, can be regulated.

In explanation, the shape of the head of the descending column 224 is recessed. However, the head may be leveled (that is, has a flat surface). In explanation, the head of the descending column 224 has a smooth surface. However, the head may have a pear-skin surface.

Further explanation is made as to the shape of the head of a descending column.

For example, as shown in FIG. 2, to adjust the size of the descending opening (which descends a molten evaporation material) from zero to a maximum value, the shape of the head of the descending column may be preferably conical or hemispherical (generically, in convex shape). However, in all cases, it is not essential to adjust the size of the descending opening. That is, in most cases, the descending opening of a fixed size can be practically used sufficiently. In such a case, the flat or recessed head of the descending column can easily provide a large descending area.

A convex head of the descending column tends to deviate the descending liquid evaporation material (liquid) from the center. Hence, the liquid runs locally down along part of the descending column. As a result, the descending rate of liquid becomes fast. It is required to extend the descending distance by the corresponding degree. However, the flat or recessed head of the descending column tends to spread thinly the descending surface of liquid and slows down the descending rate. Therefore, this feature can eliminate lengthening the descending distance and can shorten the time for which liquid converts into vapor.

### Embodiment 16

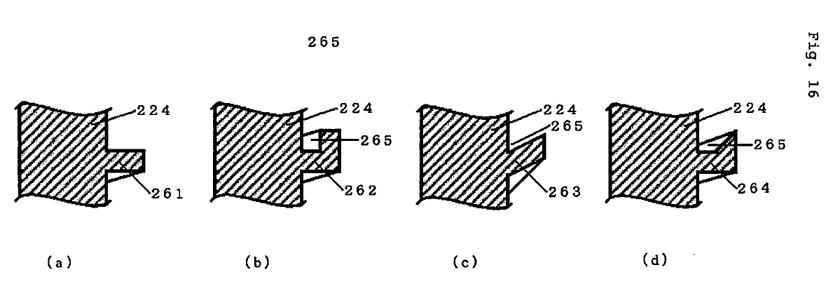

FIG. 16 shows embodiments of the descending column 224 shown in FIG. 15.

FIG. 16(a) is a partially enlarged cross-sectional view illustrating the descending column 224 of FIG. 15.

FIGS. 16(a) to 16(d) show modifications of the descending column 224 of FIG. 16(a). The descending column 224 regulates the flow of the molten evaporation material according to the shape of the helical groove (or protrusion of a helical groove) 262, 263, or 264.

In FIG. 16(a), the helical groove 261 has a square cross-section including a rectangular cross section. In contrast, the helical groove 262 of FIG. 16(b) has an L-shaped (or inverted L-shaped) cross section. The helical groove 263 of FIG. 16(c) has a parallelogram or rhombic cross section. The helical groove 264 of FIG. 16(d) has a claw-footed cross section. In either example, a flow path (recess) 265 for the molten evaporation material 32 is formed between the helical groove and the descending column 224.

Each of the descending column shown in FIGS. 16(b) to 16(d) has a special helical groove cross section. Thus, the flow of the evaporation material can be regulated.

If the flow of the evaporation material can be regulated, the helical groove of the descending column in FIG. 16 may be formed in other cross section. For example, the flow path of the evaporation material 32 may have only a recessed helical groove.

The shape of the cross section of the helical groove will be further explained here.

For a liquid evaporation material (in molten phase) having a large fluidity, one approach for lengthening the descending distance thereof is to descend the liquid evaporation material along the helical groove on the descending column. However, when there is no special obstacle, a material moves linearly. When liquid descends along the helical groove, the movement thereof works as centrifugal force. For that reason, the liquid descending along the helical groove might spill out from the helical groove. One approach for avoiding such a problem is to fence by the outside of the helical groove (crest) relatively taller than the inside thereof to prevent the descending liquid from running over from the helical groove. In other words, a protrusion is formed adjacent to the area along the outer diameter of the top surface of the crest forming the helical groove or the level of the top surface of the crest is set to be higher on the outer diameter side. Various shapes of such a structure may be proposed. An economical machining method may be employed in consideration of the shaft diameter of the descending column and pitches of the groove.

The vicinity along the outer diameter of the top surface of the crest is not limited only to the outermost area of the top surface but includes the place inward from the outer most area, for example, the intermediate portion.

The cross section of a crest of the helical groove has an upper surface, a side surface and a lower surface. The face in the direction of the head of the descending column is called the upper surface. The face confronting the inner surface of the cylindrical heater is called the side surface. The face in the direction of the bottom member of the descending column is called the lower surface.

1. An evaporation source device for a vacuum deposition apparatus, comprising:
a retainer section for retaining an evaporation material in molten state; and
an evaporator section for evaporating said evaporation material in molten state;
said evaporation material in molten state passing from said retainer section to said evaporator section through a descending opening between said retainer section and said evaporator section by gravity;
a vapor ejection opening being formed in part of a cylindrical heater in said evaporator section;
wherein said molten evaporation material, which has passed from said retainer section to said evaporator section, is evaporated by ambient radiation heat, while said molten evaporation material is descending with said molten evaporation material in no contact with an inner wall of said cylindrical heater in said evaporator, and said vapor ejection opening ejects vapor.

2. The evaporation source device defined in claim 1, further comprising a descending column disposed in said evaporator section and wherein said molten evaporation material descends on a surface of said descending column.

3. The evaporation source device defined in claim 2, wherein a surface of said descending column has a pear-skin roughness, a helical groove, a ring-shaped groove, or a vertical groove.

4. The evaporation source device defined in claim 2, wherein said descending column has a nearly erect conical shape or a nearly inverted conical shape.

5. The evaporation source device defined in claim 2, wherein said descending column can move vertically and the head of said descending column has a size or shape which can block or narrow said descending opening.

6. The evaporation source device defined in claim 1, wherein a cylindrical heater in said injector section is coupled to said ejection opening in said evaporator section, said cylindrical heater in said ejector section having an ejection opening.

7. The evaporation source device defined in claim 6, wherein said ejection opening of said ejector section has a shape of nozzle or slit.

8. The evaporation source device defined in claim 1, wherein said retainer section melts and liquefies a solid evaporation material.

9. The evaporation source device defined in claim 8, wherein an evaporation material fused and liquefied in said retainer section is supplied to said evaporator section continuously or intermittently before or during deposition.

10. An evaporation source device for a vacuum deposition apparatus, comprising:
a fusion section for melting a solid evaporation material;
a retainer section for retaining an evaporation material in a molten state; and
an evaporator section for evaporating said evaporation material in molten state;
the inside of said fusion section and the inside of said retainer section being communicated through an opening for refilling an evaporation material in molten state;
the inside of said retainer section and the inside of said evaporator section being communicated through an opening for descending an evaporation material in molten state;
said evaporator section having a vapor ejection opening; whereby said molten evaporation material in said evaporator section descends while being in no contact with the inner wall of a cylindrical heater in said evaporator section.

11. The evaporation source device defined in claim 2, wherein said descending column is rotatable.

12. The evaporation source device defined in claim 1, further comprising an adjuster for adjusting the opening area of said descending opening and adjusting the amount which said molten evaporation material falls into said evaporator.

13. The evaporation source device defined in claim 2, wherein the shape of the head of said descending column is flat or concave.

14. The evaporation source device defined in claim 1, wherein the surface of said descending column has a helical groove, the upper end of said helical groove protruding from the head of said descending column.

15. The evaporation source device defined in claim 1, wherein the surface of said descending column has a helical groove having a crest and a root; and wherein a path for said evaporation material is formed such that a protrusion is formed adjacent to the top surface of said crest and radially and outward or such that the top surface of said crest is elevated radially and outward.
